(19) United States
(12) Patent Application Publication
(10) Pub. No.: US 2026/0030596 A1
(43) Pub. Date: Jan. 29, 2026

(54) METHOD

(71) Applicant: TOYOTA JIDOSHA KABUSHIKI KAISHA, Toyota-shi (JP)

(72) Inventors: Xunan QIAN, Koto-ku (JP); Kenichiro SUGIHARA, Kounosu-shi (JP); Satoshi NAOI, Machida-shi (JP)

(73) Assignee: TOYOTA JIDOSHA KABUSHIKI KAISHA, Toyota-shi (JP)

(21) Appl. No.: 19/218,844

(22) Filed: May 27, 2025

(30) Foreign Application Priority Data
Jul. 25, 2024 (JP) 2024-120419

(51) Int. Cl. G06Q 10/1093; B60L 53/57; G06Q 10/0631; G06Q 50/06

(52) U.S. Cl. CPC G06Q 10/1093; G06Q 10/06315; G06Q 50/06; B60L 53/57

(57) ABSTRACT

An information processing apparatus accepts from a user a designation of power supply conditions under which the user requests power supply to a vehicle of the user. The information processing apparatus determines a date and time at which the power supply conditions are predicted to be satisfied as a scheduled power supply date and time. The information processing apparatus notifies the user of the scheduled power supply date and time. The information processing apparatus notifies, upon accepting a request to change the scheduled power supply date and time from the user, the user of available time slots selected based on a dispatch cost of the power supply vehicle from among available time slots during which the power supply vehicle can be dispatched. The information processing apparatus changes the scheduled power supply date and time to an available time slot selected by the user from among the available time slots.

### CROSS-REFERENCE TO RELATED APPLICATION

This application claims priority to Japanese Patent Application No. 2024-120419, filed on Jul. 25, 2024, the entire contents of which are incorporated herein by reference.

### TECHNICAL FIELD

The present disclosure relates to a method.

### BACKGROUND

Technology used for a rush power supply service in which power is supplied by a power supply vehicle when, for example, an electric vehicle (EV) runs out of electricity is known. For example, Patent Literature (PTL) 1 discloses that upon receiving a rescue request from an EV that has run out of power requesting power supply to the EV that has run out of power, a server notifies the rescue request to the vehicle that supports the same standard as the EV that has run out of power among multiple vehicles that can supply power to external apparatuses.

### CITATION LIST

### Patent Literature

PTL 1: JP 2022-139845 A

### SUMMARY

There is room for improvement with respect to technology used for a rush power supply service.

It would be helpful to improve technology used for a rush power supply service.

A method according to an embodiment of the present disclosure is a method performed by an information processing apparatus used for providing a rush power supply service that dispatches a power supply vehicle to supply power to a vehicle of a user, the method including:
accepting from the user a designation of one or more power supply conditions under which the user requests power supply to the vehicle;
determining a date and time at which the one or more power supply conditions are predicted to be satisfied as a scheduled power supply date and time;
notifying the user of the scheduled power supply date and time;
notifying, upon accepting a request to change the scheduled power supply date and time from the user, the user of one or more available time slots selected based on a dispatch cost of the power supply vehicle from among a plurality of available time slots during which the power supply vehicle can be dispatched in an operation plan; and
modifying the operation plan so as to change the scheduled power supply date and time to an available time slot selected by the user from among the one or more available time slots.

According to an embodiment of the present disclosure, technology used for a rush power supply service is improved.

### BRIEF DESCRIPTION OF THE DRAWINGS

In the accompanying drawings:

FIG. 1 is a block diagram illustrating a schematic configuration of a system according to an embodiment of the present disclosure; and

FIG. 2 is a flowchart illustrating operations of an information processing apparatus.

### DETAILED DESCRIPTION

Hereinafter, an embodiment of the present disclosure will be described.

### Outline of Embodiment

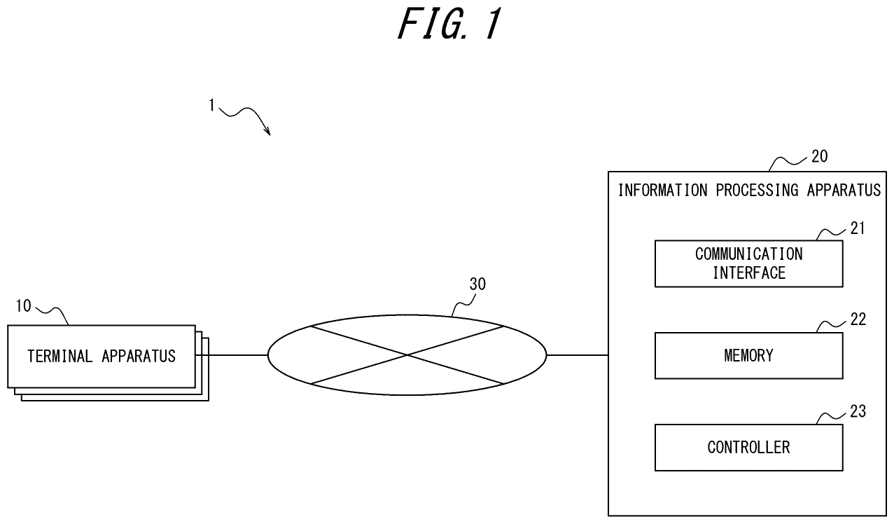

An outline of a system 1 according to the embodiment of the present disclosure will be described with reference to FIG. 1. The system 1 includes a plurality of terminal apparatuses 10 and an information processing apparatus 20. The plurality of terminal apparatuses 10 and the information processing apparatus 20 are communicably connected to a network 30 including, for example, the Internet, a mobile communication network, or the like.

The terminal apparatuses 10 are computers, such as personal computers (PCs), smartphones, or tablet terminals, for example. In the present embodiment, the terminal apparatuses 10 are used, for example, by users who use rush power supply services. The terminal apparatuses 10 may be computers mounted in the vehicles of the users.

The information processing apparatus 20 is, for example, a computer such as a server apparatus. The information processing apparatus 20 can communicate with the plurality of terminal apparatuses 10 via the network 30.

First, an outline of the present embodiment will be described, and details thereof will be described later. The information processing apparatus 20 used for providing a rush power supply service that dispatches a power supply vehicle to supply power to a vehicle of a user accepts from the user a designation of one or more power supply conditions under which the user requests power supply to the vehicle of the user. The information processing apparatus 20 then determines a date and time at which the one or more power supply conditions are predicted to be satisfied as a scheduled power supply date and time. The information processing apparatus 20 then notifies the user of the scheduled power supply date and time. The information processing apparatus 20 then notifies, upon accepting a request to change the scheduled power supply date and time from the user, the user of one or more available time slots selected based on a dispatch cost of the power supply vehicle from among a plurality of available time slots during which the power supply vehicle can be dispatched. Then, the information processing apparatus 20 changes the scheduled power supply date and time to an available time slot selected by the user from among the one or more available time slots.

A possible method for the rush power supply service is to automatically determine the scheduled power supply date and time based on the power supply conditions designated in advance by the user, without receiving a request from the user on a case-by-case basis. If such a method is adopted, it is assumed that the user may request a change in the scheduled power supply date and time once determined, because the user does not necessarily have a high degree of predictability in the scheduled power supply date and time. However, if the system is configured to allow the user to freely select a power supply date and time from among all available time slots of the power supply vehicle when changing the scheduled power supply date and time, the dispatch cost of the power supply vehicle may increase. Therefore, it is desirable that the operation plan for the power supply vehicle be determined to reduce the dispatch cost of the power supply vehicle and to supply power to the vehicle efficiently, for example, by supplying power to multiple users' vehicles in a single trip. To address these issues, according to the present embodiment, when a request to change the scheduled power supply date and time is received from the user, only one or more available time slots selected based on the dispatch cost from among the plurality of available time slots of the power supply vehicle will be presented to the user. Thus, for example, it is possible to present to the user only available time slots that do not excessively increase dispatch costs within the time slots that correspond to the user's desired power supply conditions. Therefore, according to the present embodiment, the technology used for the rush power supply service is improved in that the amount of increase in the dispatch cost of a power supply vehicle due to a change in the scheduled power supply date and time can be reduced compared to, for example, a method that presents all of the plurality of available time slots to the user.

Next, configurations of the system 1 will be described in detail.

### (Configuration of Terminal Apparatus)

As illustrated in FIG. 1, each terminal apparatus 10 communicates with the information processing apparatus 20 via the network 30. The terminal apparatus 10 includes, for example, a display for outputting information as video, a speaker for outputting information as audio, or the like. The terminal apparatus 10 also includes at least one input device for detecting an input operation by the user, such as a physical key, a capacitive key, a mouse, a touch panel, a touch screen integrally provided with a display of an output interface 12, a microphone, or the like.

### (Configuration of Information Processing Apparatus)

As illustrated in FIG. 1, the information processing apparatus 20 includes a communication interface 21, a memory 22, and a controller 23.

The communication interface 21 includes at least one communication interface for connecting to the network 30. The interface for communication is compliant with, for example, but not limited to, a mobile communication standard, a wired local area network (LAN) standard, or a wireless LAN standard, and may be compliant with any appropriate communication standard.

In the present embodiment, the information processing apparatus 20 communicates with each terminal apparatus 10 via the communication interface 21 and the network 30.

The memory 22 includes one or more memories. The memories included in the memory 22 may each function as, for example, a main memory, an auxiliary memory, or a cache memory. The memory 22 stores any information used for operations of the information processing apparatus 20.

For example, the memory 22 may store a system program, an application program, embedded software, and the like. In the present embodiment, the memory 22 stores the operation plan for the power supply vehicle.

The “operation plan for the power supply vehicle” is the schedule of power supply services to be performed by each of the one or more power supply vehicles used for the rush power supply service. The operation plan for the power supply vehicle may include schedule information, for example, what time and location each of the one or more power supply vehicles is scheduled to supply power on a given day.

The controller 23 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 23 controls operations of the entire information processing apparatus 20.

### (Flow of Operations of Information Processing Apparatus)

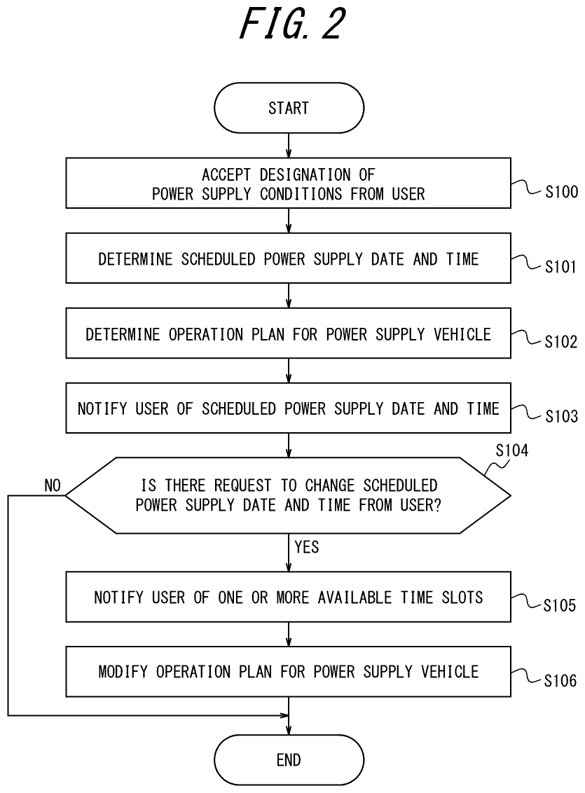

Operations of the information processing apparatus 20 according to the present embodiment will be described with reference to FIG. 2.

S100: The controller 23 of the information processing apparatus 20 accepts from the user a designation of one or more power supply conditions under which the user requests power supply to the vehicle of the user.

Specifically, the controller 23 receives from the terminal apparatus 10, via the network 30 and the communication interface 21, the designation of one or more power supply conditions requesting power supply to the vehicle of the user that the user has entered by the terminal apparatus 10 of the user. The designation of one or more power supply condition by the user may be entered by means of a form displayed on the display of the terminal apparatus 10, or any other method may be used.

The “one or more power supply conditions” may include (1) a first condition indicating that the remaining battery capacity is within a designated numerical value range, such as within 20% to 90%, (2) a second condition indicating that the scheduled power supply date and time is a designated day of week and/or a time of day, and (3) a third condition indicating that the vehicle of the user is located at a designated power supply point.

Regarding the setting of the first condition, the user may designate only the lower limit of the numerical range, and the upper limit may be pre-determined by the operator. Alternatively, the user may designate the lower and upper limits of the numerical range.

S101: The controller 23 determines the date and time when one or more power supply conditions are predicted to be satisfied as the scheduled power supply date and time.

For example, suppose that one or more power supply conditions include the first condition and the second condition. In this case, the controller 23 may receive the remaining battery capacity of the vehicle of the user from the vehicle. The controller 23 may then predict the future remaining battery capacity of the vehicle from the remaining battery capacity received from the vehicle and identify the date and time when the first condition and the second condition are predicted to be satisfied. The controller 23 may then determine the identified date and time as the scheduled power supply date and time, if the operation plan for the power supply vehicle allows one or more of the power supply vehicles to be assigned to the time of day. If there are multiple possible dates and times that can be used as the scheduled power supply date and time, the controller 23 may determine the latest of the said dates and times as the scheduled power supply date and time. Alternatively, the controller 23 may determine the earliest of such dates and times as the scheduled power supply date and time.

The availability of assigning one or more of the power supply vehicles may be based on the dispatch cost of the power supply vehicles. The “dispatch cost” of the power supply vehicle may be calculated based on factors such as, for example, a travel distance, a length of travel time, and a length of charging time or the number of replacements of the battery mounted in the power supply vehicle. Specifically, the dispatch cost may be calculated to be higher as the travel distance or the length of travel time increases, or the length of charging time or the number of replacements of the battery increases. For example, if one or more power supply conditions include a third condition where the power supply point is “Kichijoji”, the controller 23 may determine the power supply vehicle that is scheduled to supply power at “Tachikawa”, which is relatively close to “Kichijoji”, as an assignable power supply vehicle so that the travel distance is shorter.

S102: The controller 23 determines the operation plan for the power supply vehicle so that power will be supplied to the vehicle at the scheduled power supply date and time.

Specifically, the controller 23 adds the scheduled power supply date and time determined in S101 to the operation plan for the power supply vehicle stored in the memory 22.

S103: The controller 23 notifies the user of the scheduled power supply date and time.

Specifically, the controller 23 transmits the scheduled power supply date and time determined in S101 to the terminal apparatus 10 of the user via the communication interface 21 and the network 30. Then, the terminal apparatus 10 notifies the user of the scheduled power supply date and time by displaying said scheduled power supply date and time received from the information processing apparatus 20 on the screen of the terminal apparatus 10. The notification to the user can be made at any timing, for example, on a predetermined day of week or at a predetermined time before the scheduled power supply date and time. The user may be notified more than once.

When notifying the user of the scheduled power supply date and time, the controller 23 may have the user confirm whether or not the scheduled power supply date and time are acceptable. Confirmation to the user may be made, for example, by providing a “button indicating that there is no problem” such as an “OK” button and a “button indicating that you want to set another date and time” on the screen displaying the power supply date and time of the terminal apparatus 10, but any method may be employed, including but not limited to this.

There may be more than one “button indicating that another date and time” is desired. For example, the terminal apparatus 10 may provide an “earlier” button for a date and time that is a predetermined period of time earlier, such as two days, for example, than said scheduled power supply date and time, and a “later” button for a date and time that is a predetermined period of time later than said scheduled power supply date and time. The terminal apparatus 10 may further provide a “skip” button to request a change to the day of week and/or the time of day designated in the second condition, for example, in a predetermined period of time later than the scheduled power supply date and time, such as one week later. The predetermined period may be designated by the user on the screen of the terminal apparatus 10.

The buttons displayed on the screen of the terminal apparatus 10 may vary depending on the conditions. For example, the “Earlier” button may be hidden if there is no available time of day earlier than the scheduled power supply date and time, and the “Later” button may be hidden if there is no available time of day later than the scheduled power supply date and time. For example, the “Slower” or “Skip” button may be hidden if the future remaining battery capacity is predicted not to satisfy the first condition.

The controller 23 may perform S103 without performing S102, or may perform S102 only when the user presses the “No Problem” button.

S104: The controller 23 accepts a request to change the scheduled power supply date and time from the user.

Specifically, assume that the controller 23 accepted a request to change the scheduled power supply date and time from the user because the user pressed the “button indicating that the user wants to set a different date and time” in S103. Alternatively, the controller 23 may provide an interface on the screen of the terminal apparatus 10 to request a change in the scheduled power supply date and time, and accept the change request by the user using the interface to request a change in the scheduled power supply date and time.

S105: The controller 23 notifies the user of one or more available time slots selected based on the dispatch cost of a power supply vehicle from among a plurality of available time slots during which the power supply vehicle can be dispatched.

Specifically, the controller 23 notifies the user of one or more available time slots other than the scheduled power supply date and time notified to the user in S103, which were selected by adding the conditions from the user's request to change the scheduled power supply date and time accepted in S104 to the process described in S101.

For example, if the “Earlier” button is pressed by the user on the screen of the terminal apparatus 10, the controller 23 may select one or more available time slots that are a predetermined period before the scheduled power supply date and time and that satisfy the process described in S101. For example, if the “Later” button is pressed, the controller 23 may select one or more available time slots that are a predetermined period later than the scheduled power supply date and time within the same week as the scheduled power supply date and time, and that satisfy the process described in S101. Or, for example, if the “Skip” button is pressed, the controller 23 may select one or more available time slots that are a predetermined period later than the scheduled power supply date and time and that satisfy the process described in S101 for the following week.

The controller 23 then notifies the user of one or more available time slots by displaying one or more of them on the screen of the terminal apparatus 10 of the user.

S106: The controller 23 changes the scheduled power supply date and time to the available time slot selected by the user from among one or more available time slots.

Specifically, the controller 23 provides an interface on the screen of the terminal apparatus 10 of the user that allows the user to select one time slot from one or more available time slots. Various methods can be adopted for such interface, for example, a method that allows the user to directly select one or more available time slots on the screen. When the user selects one time frame, the controller 23 changes that one time slot to the scheduled power supply date and time, and updates the operation plan for the power supply vehicle stored in the memory 22 as such.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the terminal apparatus 10 can also be implemented. For example, the terminal apparatus 10 may be equipped with some or all of the components of the information processing apparatus 20.

For example, in the embodiment described above, the controller 23 may calculate respective amounts of increase in the dispatch cost in a case of changing the scheduled power supply date and time to the plurality of available time slots, and notify, upon accepting a request to change the scheduled power supply date and time from the user, the user of one or more available time slots, for which the amounts of increase are less than a threshold, from among the plurality of available time slots.

Specifically, the controller 23 calculates the amount of increase in the dispatch cost by calculating the dispatch cost for each of the plurality of available time slots based on the method for calculating the dispatch cost described in S101, and then calculating the difference from the dispatch cost for the scheduled power supply date and time before the change. The controller 23 then notifies the user only of an available time slot for which the amount of increase is less than the threshold from among the one or more available time slots selected in S105. The threshold may be changeable.

Alternatively, the controller 23 may notify the user of a specified number of available time slots in decreasing order of their respective amounts of increase from among the plurality of available time slots. The specified number may be changeable.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by an information processing apparatus, the information processing apparatus being used for providing a rush power supply service that dispatches a power supply vehicle to supply power to a vehicle of a user, the method comprising:
accepting from the user a designation of one or more power supply conditions under which the user requests power supply to the vehicle;
determining a date and time at which the one or more power supply conditions are predicted to be satisfied as a scheduled power supply date and time;
notifying the user of the scheduled power supply date and time;
notifying, upon accepting a request to change the scheduled power supply date and time from the user, the user of one or more available time slots selected based on a dispatch cost of the power supply vehicle from among a plurality of available time slots during which the power supply vehicle can be dispatched; and
changing the scheduled power supply date and time to an available time slot selected by the user from among the one or more available time slots.

2. The method according to claim 1, wherein the one or more power supply conditions include:
a first condition indicating that a remaining battery capacity is within a designated numerical value range;
a second condition indicating that the scheduled power supply date and time is a designated day of week; and
a third condition indicating that the vehicle is located at a designated power supply point.

3. The method according to claim 2, further comprising predicting a future remaining battery capacity of the vehicle,
wherein the information processing apparatus determines a date and time at which the first condition and the second condition are predicted to be satisfied as the scheduled power supply date and time.

4. The method according to claim 1, wherein the dispatch cost is calculated based on a travel distance of the power supply vehicle, a length of travel time of the power supply vehicle, and a length of charging time or a number of replacements of a battery mounted in the power supply vehicle.

5. The method according to claim 1, further comprising calculating respective amounts of increase in the dispatch cost in a case of changing the scheduled power supply date and time to the plurality of available time slots,
wherein the information processing apparatus notifies, upon accepting the request to change the scheduled power supply date and time from the user, the user of the one or more available time slots, for which the amounts of increase are less than a threshold, from among the plurality of available time slots.
